(19) United States
(12) Patent Application Publication
(10) Pub. No.: US 2009/0260048 A1
(43) Pub. Date: Oct. 15, 2009

(54) METHOD OF PROVIDING CONTENT AND CONTENT PROVIDING APPARATUS, AND METHOD OF REPRODUCING CONTENT AND CONTENT REPRODUCING APPARATUS

(75) Inventors: Sang-woong LEE, Suwon-si (KR); Sung-wook AHN, Seoul (KR); Kwang-hyuk KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/203,273

(22) Filed: Sep. 3, 2008

(30) Foreign Application Priority Data
Apr. 10, 2008 (KR) 10-2008-0033356

(51) Int. Cl. H04N 7/173

(52) U.S. Cl. 725/118; 725/131

(57) ABSTRACT

A method of providing content and a content providing apparatus, and a method of reproducing content and a content reproducing apparatus by which content reconstruction information for adjusting a content reproduction time according to a content reproduction environment is generated, and the generated content reconstruction information and the content are then transmitted.

### CROSS-REFERENCE TO RELATED PATENT APPLICATION

This application claims priority from Korean Patent Application No. 10-2008-0033356, filed on Apr. 10, 2008, in the Korean Intellectual Property Office, the disclosure of which is incorporated herein in its entirety by reference.

### BACKGROUND OF THE INVENTION

1. Field of the Invention

Apparatuses and methods consistent with the present invention relate to providing content and reproducing content in the case all the content cannot be reproduced.

2. Description of the Related Art

A broadcasting service provider obtains an advertising revenue by reproducing advertising content in a user terminal while a real-time broadcasting service is provided. In the case where the broadcasting service provider provides a broadcasting service to the user terminal via a cable network, the broadcasting service provider can allow an advertisement to be reproduced by using a digital program insertion (DPI) function defined in an Open Cable Application Platform (OCAP) standard. The DPI function refers to a function by which a cable broadcasting service provider can allow a specific advertisement to be reproduced at an advertising time by using an application such as a target engine equipped in a set-top box. When the target engine receives a control signal such as a DPI trigger from the cable broadcasting service provider, the target engine switches a broadcasting stream currently being reproduced to an advertisement stream by using a channel switch function.

Meanwhile, the broadcasting service provider is required to reproduce the advertising content only during a predefined advertising time. Otherwise, users may not be able to satisfactorily enjoy the real-time broadcasting service. However, in order to reproduce the advertisement stream while the broadcasting stream is being reproduced, a predetermined operation such as the aforementioned channel switching is necessary. Thus, even though reproduction of the broadcasting stream is discontinued, the advertisement stream cannot be immediately reproduced but can be reproduced after a predetermined delay time passes.

When the predetermined delay time is long, the predefined advertising time may be less than a total reproducing time of the advertising content. In this case, an end part of the advertising content has to be omitted so as to provide the real-time broadcasting service, or a part of the real-time broadcasting service has to be omitted so as to reproduce the advertising content. In the former case, an advertiser cannot efficiently deliver an advertisement, and in the latter case, it is inconvenient for the users since a user desired broadcasting program cannot be watched.

In the above, it is assumed that the advertisement stream is transmitted via a channel that is different from the broadcasting stream. However, in cases where an advertisement stream is transmitted in a channel equal to a broadcasting stream by using a different technique, is transmitted via a web, or is stored in a user terminal, a predetermined operation is also required so as to switch the broadcasting stream to the advertisement stream and to reproduce the advertisement stream. Thus, the advertisement stream may not be reproduced during a predefined advertising time period.

A part of the content must be omitted not only due to the advertising content but also for various other reasons, for example, a user may not have enough time to reproduce the content, or a total content reproduction-enabled time is less than a total reproducing time of the content since an available time for a battery supplying power to the user terminal is limited. If important information is included in the omitted part of the content, the user may not efficiently obtain information.

### SUMMARY OF THE INVENTION

The present invention provides a method of providing content and a content providing apparatus, and a method of reproducing content and a content reproducing apparatus, which enable content to be efficiently reproduced even when there is a time limit with respect to reproduction of the content.

According to an aspect of the present invention, there is provided a method of providing content, the method including: generating content reconstruction information for adjusting a content reproduction time according to a content reproduction environment; and transmitting the generated content reconstruction information and the content.

The content reproduction environment may include a reproduction-enabled time that represents a time interval during which a user terminal that received the content can reproduce the content.

The content reconstruction information may include start position information of a reproduction section to be reproduced from among a plurality of sections forming the content, and reproduction section length information indicating a difference between a start position of the reproduction section and an end position of the reproduction section.

The generating content reconstruction information may include generating a plurality of pieces of content reconstruction information respectively corresponding to each of reproduction-enabled times, and the transmitting the generated content reconstruction information and the content may include transmitting the generated plurality of pieces of content reconstruction information.

The content reconstruction information may include start position information of a skip section not to be reproduced from among a plurality of sections forming the content, and skip section length information indicating a difference between a start position of the skip section and an end position of the skip section.

The content reconstruction information may include a reproduction priority for each of a plurality of sections forming the content.

According to another aspect of the present invention, there is provided a method of reproducing content, the method including: receiving content reconstruction information for adjusting a content reproduction time according to a content reproduction environment, and the content; collecting information about the content reproduction environment; and reconstructing and reproducing the content based on the information about the content reproduction environment and the content reconstruction information.

The information about the content reproduction environment may include a reproduction-enabled time that represents a time interval during which the content can be reproduced.

The content reconstruction information may include a start position of a reproduction section to be reproduced from among a plurality of sections forming the content, and reproduction section length information indicating a difference between the start position of the reproduction section and an end position of the reproduction section.

The receiving content reconstruction information may include receiving a plurality of pieces of content reconstruction information respectively corresponding to each of a plurality of reproduction-enabled times, and the reconstructing and reproducing the content may include reconstructing and reproducing the content based on content reconstruction information which corresponds to the collected information about the reproduction-enabled time and which is from among the plurality of pieces of content reconstruction information.

The content reconstruction information may include start position information of a skip section not to be reproduced from among a plurality of sections forming the content, and skip section length information indicating a difference between a start position of the skip section and an end position of the skip section.

The content reconstruction information may include a reproduction priority for each of a plurality of sections forming the content.

According to another aspect of the present invention, there is provided a content providing apparatus including: an information generation unit generating content reconstruction information for adjusting a content reproduction time according to a content reproduction environment; and a transmitting unit transmitting the generated content reconstruction information and the content.

According to another aspect of the present invention, there is provided a content reproducing apparatus including: a receiving unit receiving content reconstruction information for adjusting a content reproduction time according to a content reproduction environment, and receiving the content; an information collection unit collecting information about the content reproduction environment; and a reproduction unit reconstructing and reproducing the content based on the information about the content reproduction environment and the content reconstruction information.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a content providing apparatus according to an exemplary embodiment of the present invention;

FIG. 2 is a block diagram of a content reproducing apparatus according to another exemplary embodiment of the present invention;

FIG. 3A is a diagram of content reconstruction information according to another exemplary embodiment of the present invention;

FIGS. 3B through 3D illustrate content reproduction by a content reproducing apparatus according to a reproduction-enabled time, according to exemplary embodiments of the present invention;

FIG. 4A is a diagram of content reconstruction information according to another exemplary embodiment of the present invention;

FIG. 4B illustrates content reproduction by a content reproducing apparatus according to a reproduction-enabled time, according to another exemplary embodiment of the present invention;

FIG. 5 is a diagram of content reconstruction information according to another exemplary embodiment of the present invention;

FIG. 6 is a flowchart of a method of providing content, according to another exemplary embodiment of the present invention; and

FIG. 7 is a flowchart of a method of reproducing content, according to another exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

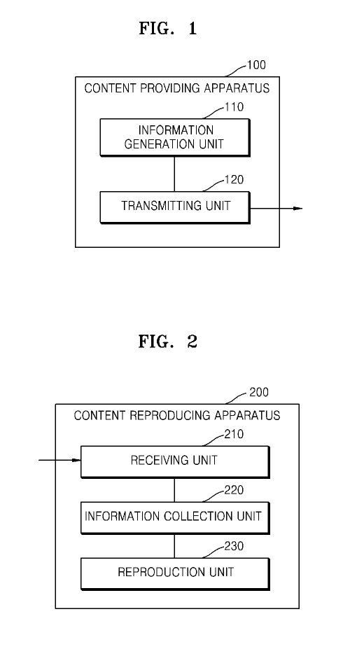

FIG. 1 is a block diagram of a content providing apparatus 100 according to an exemplary embodiment of the present invention.

The content providing apparatus 100 according to an exemplary embodiment of the present invention may include an information generation unit 110 and a transmitting unit 120.

The information generation unit 110 generates content reconstruction information. The content reconstruction information in the present invention may represent information for adjusting a content reproduction time according to a content reproduction environment. The content reproduction environment may include a reproduction-enabled time that is a time interval during which a user terminal receiving content can reproduce the content.

In the case where there is a time limit with respect to reproduction of content, such as when a content reproduction time is prescribed like an advertising time, when a user attempts to reproduce content at 2× speed, and when an available time for a power supplying battery is limited, the reproduction-enabled time represents the time interval during which the user terminal can reproduce the content. In the case where the reproduction-enabled time is less than a total reproducing time of the content, the user terminal is required to properly reconstruct and reproduce the content. Examples of the content reconstruction information, which enables the user terminal to properly reconstruct and reproduce the content, are given below.

In the case where a user terminal may not reproduce entire content due to a time limit, the entire content is divided into a plurality of sections, and from among the plurality of sections, a reproduction section indicating a section to be reproduced and a skip section indicating a section that is not to be reproduced are determined. At this time, the content reconstruction information may include at least one of information about the reproduction section and information about the skip section.

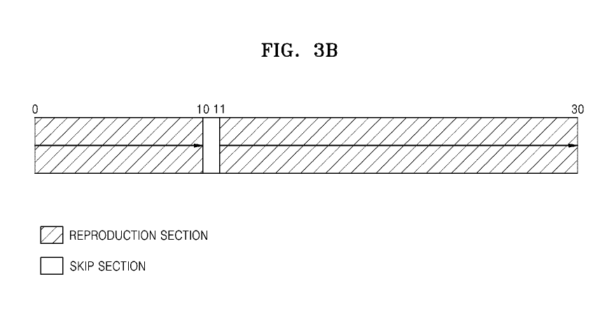

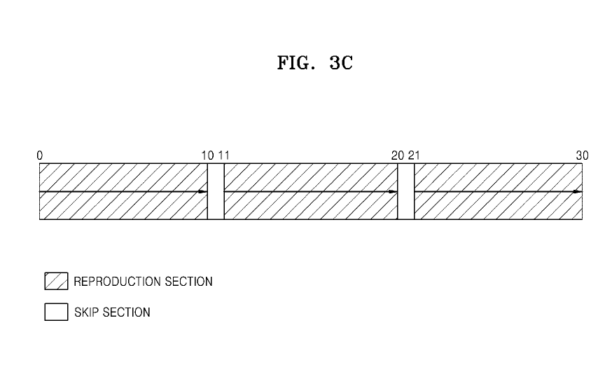

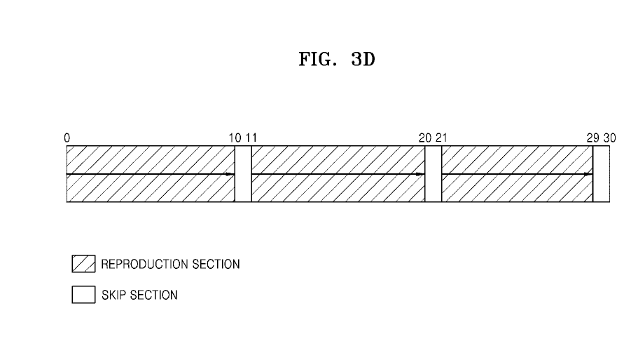

When the reproduction section is longer than the skip section, the content reproduction information only includes the information about the skip section so as to reduce a total amount of data used to generate the content reconstruction information. To be more specific, the content reproduction information may include start position information of the skip section, and skip section length information. The skip section length information indicates a difference between a start position of the skip section and an end position of the skip section, and indicates a duration time of the skip section. An exemplary embodiment regarding the content reconstruction information including the information about the skip section will be described later with reference to FIG. 3.

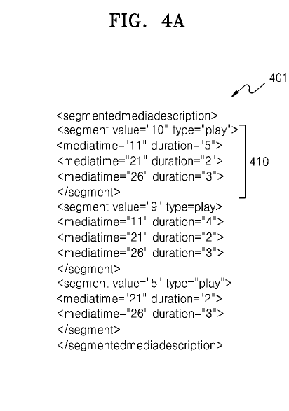

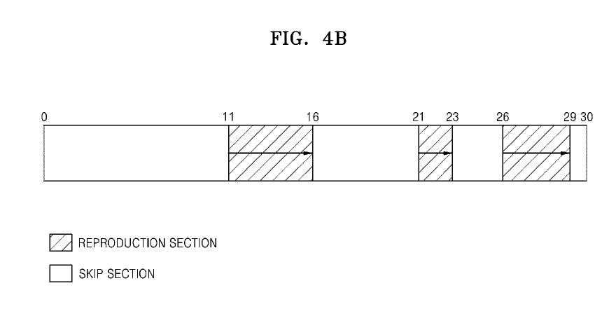

On the other hand, when the skip section is longer than the reproduction section, the content reproduction information only includes the information about the reproduction section. To be more specific, the content reproduction information may include start position information of the reproduction section, and reproduction section length information. The reproduction section length information indicates a difference between a start position of the reproduction section and an end position of the reproduction section, and indicates a duration time of the reproduction section. An exemplary embodiment regarding the content reconstruction information including the information about the reproduction section will be described later with reference to FIG. 4.

Any information that can be used to specify a position of the reproduction section and a position of the skip section may be the information of the reproduction section and the information of the skip section. Thus, the start position and the end position of the reproduction section (or the skip section) may be used instead of start position information of the reproduction section and reproduction section length.

Since a reproduction-enabled time in a user terminal cannot be predicted, the content providing apparatus 100 may generate a plurality of pieces of content reproduction information respectively corresponding to each of a plurality of reproduction-enabled times. In this case, the user terminal may reconstruct content by using the plurality of pieces of content reproduction information corresponding to the user terminal.

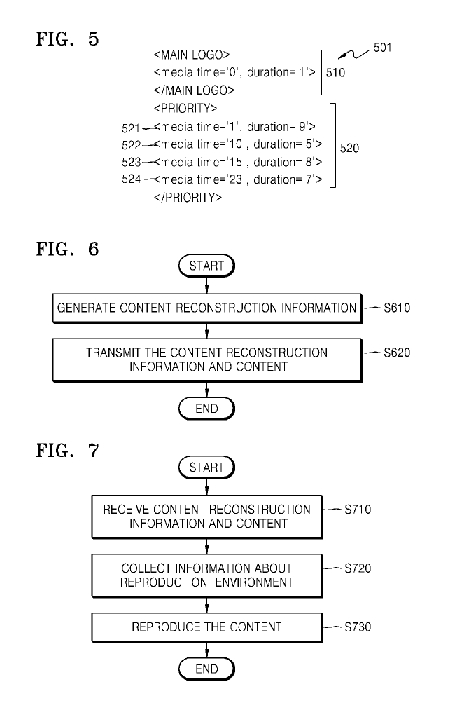

In an exemplary embodiment, the content providing apparatus 100 determines the reproduction section and the skip section. However, the reproduction section and the skip section may be determined in the user terminal. At this time, the content reconstruction information may include section information by which the user terminal may determine the reproduction section and the skip section. For example, the content reconstruction information may include a reproduction priority for each of the plurality of sections. If the reproduction-enabled time is shorter than the total reproducing time of the content, the user terminal determines at least one section having a relatively low reproduction priority as the skip section, and determines at least another section having a relatively high reproduction priority as the reproduction section. An exemplary embodiment regarding the content reproduction information including information about the reproduction priority will be described later with reference to FIG. 5.

The transmitting unit 120 transmits the generated content reconstruction information and the content to the user terminal. The content reconstruction information may be included in metadata about the content and transmitted, or may be transmitted separately from the metadata. The transmitting unit 120 transmits the content reconstruction information and the content via various communication networks such as a cable network, an Internet network, and the like.

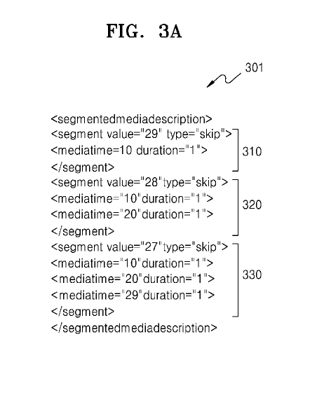

FIG. 2 is a block diagram of a content reproducing apparatus 200 according to another exemplary embodiment of the present invention.

The content reproducing apparatus 200 may include a receiving unit 210, an information collection unit 220, and a reproduction unit 230.

The receiving unit 210 receives the content reconstruction information and the content from the content providing apparatus 100. As described above, the content reconstruction information is used to adjust the content reproduction time according to the content reproduction environment.

The information collection unit 220 collects information about the content reproduction environment. The information about the content reproduction environment may include a reproduction-enabled time.

The reproduction-enabled time may be obtained from a user input signal. When a user selects reproduction at 2× speed (or, 4× speed), ½ (or, ¼) of a total reproducing time of content is determined as the reproduction-enabled time.

Also, the reproduction-enabled time may be obtained by analyzing external conditions such as an amount of power enabled to be used by the content reproducing apparatus 200, a remaining advertising time, and the like. In the case where an advertising time is 10 minutes, and it takes one minute to perform a predetermined operation necessary for reproduction of advertising content, nine minutes are determined as the reproduction-enabled time.

The reproduction unit 230 reconstructs and reproduces the content based on the information about the content reproduction environment, and the content reconstruction information. The reproduction unit 230 reconstructs the content according to a format of the content reconstruction information.

First, provided is a case in which the content reconstruction information includes information about a reproduction section. More specifically, the information about the reproduction section may include a start position of the reproduction section, and reproduction section length information. In the case where the reproduction-enabled time is shorter than the total reproducing time of content, the reproduction unit 230 scans the reproduction section by using the information about the reproduction section, and reproduces only the reproduction section. However, if the reproduction-enabled time is longer than the total reproducing time of content, the reproduction unit 230 reproduces received content without change.

Second, provided is a case in which the content reconstruction information includes information about a skip section. More specifically, the information about the skip section may include a start position of the skip section, and skip section length information. In the case where the reproduction-enabled time is shorter than the total reproducing time of content, the reproduction unit 230 scans the skip section by using the information about the skip section, and reproduces remaining sections excluding the skip section.

The receiving unit 210 may receive a plurality of pieces of content reconstruction information respectively corresponding to each of a plurality of reproduction-enabled times. When the plurality of pieces of content reconstruction information are received, the reproduction unit 230 searches for content reconstruction information which corresponds to reproduction-enabled time information collected by the information collection unit 220 and which is from among the plurality of pieces of content reconstruction information. When the corresponding content reconstruction information is searched for, the reproduction unit 230 reconstructs and reproduces content based on the corresponding content reconstruction information.

Next, provided is a case in which the content reconstruction information includes a reproduction priority for each of a plurality of sections. In this case, content is divided into the plurality of sections according to a predetermined basis, and the reproduction priority is allocated to each of the plurality of sections. In the case where a reproduction-enabled time is shorter than a total reproducing time of content, the reproduction unit 230 determines a lowest priority section as a skip section.

In the case where the reproduction-enabled time is longer than a content reproducing time excluding the lowest priority section, the reproduction unit 230 reproduces remaining sections excluding the skip section. However, in the case where the reproduction-enabled time is shorter than the content reproducing time excluding the lowest priority section, the reproduction unit 230 determines a second-lowest priority section as the skip section and determines whether or not to reproduce remaining sections. In this manner, the reproduction unit 230 arranges the reproduction-enabled time to be longer than the content reproducing time excluding the skip section, and reproduces remaining sections excluding the skip section.

In the case where the reproduction-enabled time is longer than an actual reproducing time of content, the content reconstruction information may include information about a section to be repeatedly reproduced. Hereinafter, for convenience of description, the section to be repeatedly reproduced is referred to as a ‘repeat reproduction section’. The reproduction unit 230 repeatedly reproduces the repeat reproduction section not only when the reproduction-enabled time is longer than the total reproducing time of content but also when the actual reproducing time of content becomes shorter than the reproduction-enabled time by reconstructing the content. That is, when reproduction of the reconstructed content is ended, the repeat reproduction section is repeatedly reproduced until the actual reproducing time of content reaches the reproduction-enabled time.

FIG. 3A is a diagram of metadata 301 according to another exemplary embodiment of the present invention.

The metadata 301 of FIG. 3A includes three pieces of content reconstruction information 310, 320, and 330. The three pieces of content reconstruction information 310, 320, and 330 include information about a skip period. It is assumed that a total reproducing time of content is 30 seconds, and start position information of the skip section and skip section length information are temporally displayed.

The variable ‘segment value’ represents a reproduction-enabled time corresponding to content reconstruction information. Thus, the content reconstruction information 310 is used when the reproduction-enabled time is 29 seconds, the content reconstruction information 320 is used when the reproduction-enabled time is 28 seconds, and the content reconstruction information 330 is used when the reproduction-enabled time is 27 seconds.

The variable ‘type’ represents a type of corresponding content reconstruction information. In the case of ‘type=skip’, this means that the corresponding content reconstruction information includes information about a skip section.

In the case of ‘type=skip’, the variable ‘mediatime’ represents a start position of the skip section.

In the case of ‘type=skip’, the variable ‘duration’ represents the skip section length information.

FIG. 3B illustrates content reproduction when a reproduction-enabled time is 29 seconds, according to an exemplary embodiment of the present invention.

The information collection unit 220 collects information about the reproduction-enabled time as information about a content reproduction environment. It is assumed in this exemplary embodiment that the reproduction-enabled time is 29 seconds.

In the case where the reproduction-enabled time is 29 seconds, content is reconstructed by using the content reconstruction information 310. Referring to the content reconstruction information 310, it is possible to understand that a section from second 10 to second 11 is a skip section when the reproduction-enabled time is 29 seconds. Thus, the reproduction unit 230 reproduces remaining sections excluding the section from second 10 to second 11.

FIG. 3C illustrates content reproduction when a reproduction-enabled time is 28 seconds, according to another exemplary embodiment of the present invention.

In the case where the reproduction-enabled time is 28 seconds, content is reconstructed by using the content reconstruction information 320. Referring to the content reconstruction information 320, it is possible to understand that a section from second 10 to second 11, and a section from second 20 to second 21 are skip sections when the reproduction-enabled time is 28 seconds. Thus, the reproduction unit 230 reproduces remaining sections excluding the section from second 10 to second 11 and the section from second 20 to second 21.

FIG. 3D illustrates content reproduction when a reproduction-enabled time is 27 seconds, according to another exemplary embodiment of the present invention.

In the case where the reproduction-enabled time is 27 seconds, content is reconstructed by using the content reconstruction information 330. Referring to the content reconstruction information 330, it is possible to understand that a section from second 10 to second 11, a section from second 20 to second 21, and a section from second 29 to second 30 are skip sections when the reproduction-enabled time is 27 seconds. Thus, the reproduction unit 230 reproduces remaining sections excluding the section from second 10 to second 11, the section from second 20 to second 21, and the section from second 29 to second 30.

FIG. 4A is a diagram of metadata 401 according to another exemplary embodiment of the present invention.

The metadata 401 of FIG. 4A includes three pieces of content reconstruction information which respectively include information about a reproduction section. A total reproducing time of content is 30 seconds, and start position information of the reproduction section and reproduction section length information are temporally displayed.

The variable ‘type’ represents a type of corresponding content reconstruction information. In the case of ‘type=play’, this means that the corresponding content reconstruction information includes the information about the reproduction section.

In the case of ‘type=play’, the variable ‘mediatime’ represents a start position of the reproduction section, and ‘duration’ represents the reproduction section length information.

FIG. 4B illustrates content reproduction when a reproduction-enabled time is 10 seconds, according to another exemplary embodiment of the present invention.

In the case where the reproduction-enabled time is 10 seconds, content is reconstructed by using content reconstruction information 410. Referring to the content reconstruction information 410, it is possible to understand that a section from second 11 through to second 16, a section from second 21 through to second 23, and a section from second 26 through to second 29 are reproduction sections when the reproduction-enabled time is 10 seconds. Thus, the reproduction unit 230 reproduces the section from second 11 through to second 16, the section from second 21 through to second 23, and the section from second 26 through to second 29.

FIG. 5 is a diagram of metadata according to another exemplary embodiment of the present invention.

In FIG. 5, content is divided into a plurality of sections. Content reconstruction information 501 forming the metadata includes a plurality of pieces of section information 510 and 520. Also, the section information 510 and 520 include a reproduction priority for each section.

In exemplary embodiments, it is assumed that a total reproducing time of the content is 30 seconds, and the content is divided into first through fifth sections. The first section may be a section in which a main logo is reproduced. Also, in the case where a reproduction-enabled time is longer than an actual reproducing time of content, the first section may be repeatedly reproduced until the actual reproducing time of content reaches the reproduction-enabled time. Referring to the content reconstruction information 501, it is possible to understand that a duration time of the first section is one second, that is, second 0 (start position) to second 1.

Referring to the content reconstruction information 501, it is possible to understand that a duration time of the second section is nine seconds, that is, from second 1 through to second 10. Similarly, a section from second 10 through to second 15 is the third section, a section from second 15 through to second 23 is the fourth section, and a section from second 23 through to second 30 is the fifth second. Also, a reproduction priority for each section is sequentially from the second section, the third section, the fourth section, and the fifth section to which 1, 2, 3, and 4 are respectively allocated. A reproduction priority may be allocated to each section according to various standards such as the importance of each section. The reproduction priority in FIG. 5 is allocated to each section according to the importance of each section, and it is assumed that the first section having the reproduction priority 1 is the most important section and has the highest priority.

When the reproduction-enabled time obtained by the information collection unit 220 is 22 seconds, the reproduction-enabled time is shorter than the total reproducing time of the content. Thus, the reproduction unit 230 determines a lowest priority section as a skip section. In FIG. 5, the fifth section is determined as the skip section. Since the duration time of the fifth section is 7 seconds, a duration time of content excluding the fifth section is 23 seconds.

Even though the fifth section is excluded, the reproduction-enabled time is shorter than an actual reproducing time of the content. Thus, the reproduction unit 230 determines a second-lowest priority section as the skip section. In FIG. 5, the fourth section is determined as the skip section. Since the duration time of the fourth section is 8 seconds, the actual reproducing time of the content excluding the fourth and fifth sections is 15 seconds.

The reproduction-enabled time is longer than the actual reproducing time of the content excluding the fourth and fifth sections. Thus, the reproduction unit 230 reproduces remaining sections excluding the fourth and fifth sections. In this case, the actual reproducing time of the content is only 15 seconds so that the first section may be repeatedly reproduced during the remaining 7 seconds.

FIG. 6 is a flowchart of a method of providing content, according to another exemplary embodiment of the present invention.

In operation S610, content reconstruction information is generated. The content reconstruction information is used to adjust a content reproduction time according to a content reproduction environment. The content reproduction environment may represent a reproduction-enabled time that is a time interval during which a user terminal receiving content can reproduce the content.

The content reconstruction information may include reproduction section information such as start position information of a reproduction section in which content is reproduced, and reproduction section length information indicating a difference between a start position of the reproduction section and an end position of the reproduction section. The content reconstruction information may also include skip section information such as start position information of a skip section in which the content is not reproduced, and skip section length information indicating a difference between a start position of the skip section and an end position of the skip section. At this time, a plurality of pieces of content reconstruction information respectively corresponding to each of reproduction-enabled times may be generated.

The content reconstruction information may include a reproduction priority for each of a plurality of sections forming the content.

In operation S620, the generated content reconstruction information and the content are transmitted.

FIG. 7 is a flowchart of a method of reproducing content, according to another exemplary embodiment of the present invention.

In operation S710, content reconstruction information and content are received. A plurality of pieces of content reconstruction information respectively corresponding to each of a plurality of reproduction-enabled times may be received. The reproduction-enabled times represents a time interval during which a user terminal can reproduce content.

In operation S720, information about a content reproduction environment is collected. The information about the content reproduction environment may include information about a reproduction-enabled time of the user terminal that received the content.

In operation S730, the content is reconstructed and reproduced. In the case where the plurality of pieces of content reconstruction information are received, content reconstruction information corresponding to the information about the reproduction-enabled time collected in operation S720 is scanned, and the content is reconstructed based on the scanned content reconstruction information.

Exemplary embodiments of the present invention reconstruct and reproduce content by using content reconstruction information, thereby enabling to efficiently deliver important information even when entire content cannot be reproduced due to a time limit.

Also, exemplary embodiments of the present invention reconstruct and reproduce advertising content according to a time limit, thereby maximizing an effect of an advertisement.

The exemplary embodiments of the present invention can be written as computer programs and can be implemented in general-use digital computers that execute the programs using a computer readable recording medium.

Examples of the computer readable recording medium include magnetic storage media (e.g., ROM, floppy disks, hard disks, etc.), optical recording media (e.g., CD-ROMs, or DVDs).

In another exemplary embodiment, the computer readable medium may include carrier waves (e.g., transmission through the Internet).

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of providing content, the method comprising:
generating content reconstruction information for adjusting a content reproduction time according to a content reproduction environment; and
transmitting the generated content reconstruction information and the content.

2. The method of claim 1, wherein the content reproduction environment comprises a reproduction-enabled time that represents a time interval during which a user terminal that receives the transmitted content can reproduce the content.

3. The method of claim 2, wherein the generating comprises generating a plurality of pieces of content reconstruction information respectively corresponding to each of a plurality of reproduction-enabled times, and the transmitting comprises transmitting the generated plurality of pieces of content reconstruction information.

4. The method of claim 1, wherein the content reconstruction information comprises start position information of a reproduction section to be reproduced from among a plurality of sections forming the content, and reproduction section length information indicating a difference between a start position of the reproduction section and an end position of the reproduction section.

5. The method of claim 1, wherein the content reconstruction information comprises start position information of a skip section not to be reproduced from among a plurality of sections forming the content, and skip section length information indicating a difference between a start position of the skip section and an end position of the skip section.

6. The method of claim 1, wherein the content reconstruction information comprises a reproduction priority for each of a plurality of sections forming the content.

7. A method of reproducing content, the method comprising:
receiving content reconstruction information for adjusting a content reproduction time according to a content reproduction environment;
receiving the content;
collecting information about the content reproduction environment; and
reconstructing and reproducing the content based on the information about the content reproduction environment and the content reconstruction information.

8. The method of claim 7, wherein the information about the content reproduction environment comprises a reproduction-enabled time that represents a time interval during which the content is able to be reproduced.

9. The method of claim 8, wherein the receiving the content reconstruction information comprises receiving a plurality of pieces of content reconstruction information respectively corresponding to each of a plurality of reproduction-enabled times, and the reconstructing and reproducing comprises reconstructing and reproducing the content based on content reconstruction information which corresponds to the collected information about the reproduction-enabled time and which is from among the plurality of pieces of content reconstruction information.

10. The method of claim 7, wherein the content reconstruction information comprises a start position of a reproduction section to be reproduced from among a plurality of sections forming the content, and reproduction section length information indicating a difference between the start position of the reproduction section and an end position of the reproduction section.

11. The method of claim 7, wherein the content reconstruction information comprises start position information of a skip section not to be reproduced from among a plurality of sections forming the content, and skip section length information indicating a difference between a start position of the skip section and an end position of the skip section.

12. The method of claim 7, wherein the content reconstruction information comprises a reproduction priority for each of a plurality of sections forming the content.

13. A content providing apparatus comprising:
an information generation unit which generates content reconstruction information for adjusting a content reproduction time according to a content reproduction environment; and
a transmitting unit which transmits the generated content reconstruction information and the content.

14. The content providing apparatus of claim 13, wherein the content reproduction environment comprises a reproduction-enabled time that represents a time interval during which a user terminal that receives the content can reproduce the content.

15. The content providing apparatus of claim 14, wherein the information generation unit generates a plurality of pieces of content reconstruction information respectively corresponding to each of a plurality of reproduction-enabled times, and the transmitting unit transmits the generated plurality of pieces of content reconstruction information.

16. The content providing apparatus of claim 13, wherein the content reconstruction information comprises start position information of a reproduction section to be reproduced from among a plurality of sections forming the content, and reproduction section length information indicating a difference between a start position of the reproduction section and an end position of the reproduction section.

17. The content providing apparatus of claim 13, wherein the content reconstruction information comprises start position information of a skip section not to be reproduced from among a plurality of sections forming the content, and skip section length information indicating a difference between a start position of the skip section and an end position of the skip section.

18. The content providing apparatus of claim 13, wherein the content reconstruction information comprises a reproduction priority for each of a plurality of sections forming the content.

19. A content reproducing apparatus comprising:
a receiving unit which receives content reconstruction information for adjusting a content reproduction time according to a content reproduction environment, and which also receives the content;
an information collection unit which collects information about the content reproduction environment; and
a reproduction unit which reconstructs and reproduces the content based on the information about the content reproduction environment and the content reconstruction information.

20. The content reproducing apparatus of claim 19, wherein the information about the content reproduction environment comprises a reproduction-enabled time that represents a time interval during which the reproduction unit can produce the content.

21. The content reproducing apparatus of claim 20, wherein the receiving unit receives a plurality of pieces of content reconstruction information respectively corresponding to each of a plurality of reproduction-enabled times, and the reproduction unit reconstructs and reproduces the content based on content reconstruction information which corresponds to the collected information about the reproduction-enabled time and which is from among the plurality of pieces of content reconstruction information.

22. The content reproducing apparatus of claim 19, wherein the content reconstruction information comprises a start position of a reproduction section to be reproduced from among a plurality of sections forming the content, and reproduction section length information indicating a difference between the start position of the reproduction section and an end position of the reproduction section.

23. The content reproducing apparatus of claim 19, wherein the content reconstruction information comprises start position information of a skip section not to be reproduced from among a plurality of sections forming the content, and skip section length information indicating a difference between a start position of the skip section and an end position of the skip section.

24. The content reproducing apparatus of claim 19, wherein the content reconstruction information comprises a reproduction priority for each of a plurality of sections forming the content.

25. A computer readable recording medium having recorded thereon a program for executing the method of claim 1.
